(19) United States
(12) Patent Application Publication
(10) Pub. No.: US 2011/0068273 A1
(43) Pub. Date: Mar. 24, 2011

(54) Device and Method for Detecting High Energy Radiation Through Photon Counting

(75) Inventors: Fu-Jen KAO, Taipei (TW); Cheng-Chi WU, Taipei (TW)

(73) Assignee: NATIONAL YANG MING UNIVERSITY, Taipei (TW)

(21) Appl. No.: 12/628,915

(22) Filed: Dec. 1, 2009

(30) Foreign Application Priority Data
Sep. 18, 2009 (TW) 098131504

(51) Int. Cl. G01T 1/20

(52) U.S. Cl. 250/362; 250/368

(57) ABSTRACT

The present invention relates to a radiation-detecting device and an associated detection method. The detection device includes a scintillation crystal and an avalanche photodiode. The surface of the scintillation crystal is coated with a high-reflection layer. When ionizing radiation irradiates the scintillation crystal, the crystal emits luminescence, which passes through or is reflected by the high-reflection layer at least once within the scintillation crystal before it is received by the avalanche photodiode, generating a detection signal.

### BACKGROUND OF THE INVENTION

1. Field of the Invention

The present invention relates to a device for detecting radiation, and in particular, through counting photons.

2. Prior Art

High-energy radiation, such as from sunshine, exists naturally in the environment, including in air and water. It is colorless, tasteless and odorless, and therefore cannot be sensed by human being. It therefore causes a fear of the unknown.

Since the discovery of radiation, more than a century ago, people have been trying to exploit its unique properties, such as in X-ray scanning, food product preservation, and the examination of metallic structures. These applications have greatly improved daily life.

High-energy radiation has several forms. The first is radioactive nuclear species, formed when an unstable nucleus eliminates excess energy by means of electromagnetic waves. The second is accelerated charged particles from instruments that generate X-rays, such as X-ray tubes or synchrotron radiation accelerators; X-ray tubes are important in medical devices. The third is background radiation throughout the universe, including cosmic rays. Specialized materials are commonly adopted to detect high-energy radiation.

Several devices exist for detecting various species of radiation. They include dose badges for personnel, radiation dose pens, portable radiation detecting devices, environment monitors and others. The aforementioned detecting devices other than dose badges and radiation dose pens are too large to carry. Dose badges and radiation dose pens operate on the same principles as the photographic film. Both the badges and pens are worn on the chest at work for about one month. The used badges and pens are developed and fixed to determine the dosage of radiation, which depends on the period of exposure of the films. The radiation measuring process is relatively complex and time-consuming.

### SUMMARY OF THE INVENTION

The purpose of the present invention is to function as a high-energy radiation detecting device and to overcome the disadvantages of existing methods and devices.

The radiation-detecting device provided comprises a scintillation crystal and an avalanche photodiode. The surface of the scintillation crystal is coated with a high-reflection layer. The avalanche photodiode couples to the scintillation crystal. When the radiation is incident on the scintillation crystal, the crystal emits luminescence, which is transmitted within the crystal or received by the avalanche photodiode via at least one reflection by the high-reflection layer, generating the detection signals. In this invention, the avalanche photodiode is adopted to reduce the size of the radiation-detecting device. Additionally, the scintillation crystal that is adopted in this invention has the shape of a funnel (like a waveguide); therefore, luminescence photons can be effectively detected by the avalanche photodiode.

A radiation-detecting method is also provided. The detection method exploits the scintillation crystal and the avalanche photodiode; the surface of the scintillation crystal is coated with a high-reflection layer, and the avalanche photodiode couples to the scintillation crystal. The aforementioned detection method involves the irradiation of the scintillation crystal; the generation of luminescence by the scintillation crystal; the reflection of the luminescence by the high-reflection layer; the absorption of the luminescence by the avalanche photodiode, and the generation of a detection signal by the avalanche photodiode.

The advantages of the present invention are as follows. The irradiated scintillation crystal produces luminescence, and highly reflected layer that is coated on the surface of the scintillation crystal to increases the reflectance of light within the crystal. The intensity of the luminescence is measured by the avalanche photodiode and the strength of the radiation is thus obtained. The reaction rate of these scintillation processes is high, and substantially reduces the required detection time. The size of the instrument is also reduced to facilitate portability. The cost is lower than that of prior techniques, whose disadvantages in bulkiness and complexity are largely overcome.

The aforementioned aspects of this invention and many of their advantages will become more evident and understandable with reference to the following detailed description and drawings will elucidate the aforementioned aspects of this invention and many of its advantages.

### BRIEF DESCRIPTION OF THE DRAWINGS

FIG. 1 presents a system chart of an example of the newly invented radiation-detecting device.

FIG. 2 presents a flow chart of an example of application of the described radiation-detecting method using the present invention.

### DETAILED DESCRIPTION OF THE INVENTION

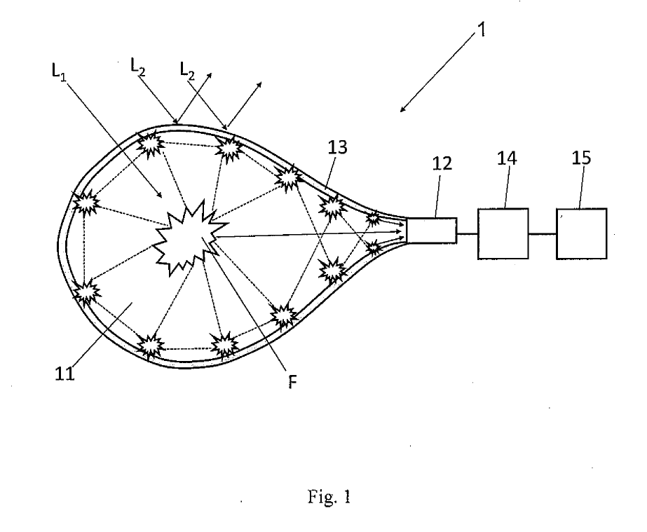

FIG. 1 presents the system chart of the newly invented radiation-detecting device. Radiation detecting device 1, in its preferred embodiment, comprises the scintillation crystal 11, the avalanche photodiode 12, the signal processing unit 14, and the display unit 15; the surface of the scintillation crystal 11 is coated with a high-reflection layer 13.

In the present embodiment, the preferred material for layer 13 is metal, which is high-reflection. The best material for forming the high-reflection layer 13 is aluminum; however, other metallic materials may be adopted.

In the present embodiment, scintillation crystal 11 may be, but is not limited to sodium iodide. Additionally, the preferred shape of the scintillation crystal 11 is that of a funnel. The avalanche photodiode 12 can be, but need not be, the opening of the funnel-shaped scintillation crystal 11.

In the present embodiment, the operating principles of the avalanche photodiode 12 are as follows. Absorption of the carriers that are generated by the photons makes the avalanche photodiode 12 multiplicative by affecting the ionization process, because the carriers receive more kinetic energy when they move in an electric filed. If the kinetic energy is stronger than the energy gap E_{g}, then the valence band electrons will collide with the conduction band and then generate electron-hole pairs. More electrons or holes are generated. The multiplicative carriers produce a current gain which causes more detection signals to be output.

In the present embodiment, the gain-bandwidth product of the avalanche photodiode can be 70 GHz.

In FIG. 1, the avalanche photodiode 12 is coupled to the scintillation crystal 11; the signal processing unit 14 is coupled to the avalanche photodiode 12, and the display unit 15 is coupled to the signal processing unit 14.

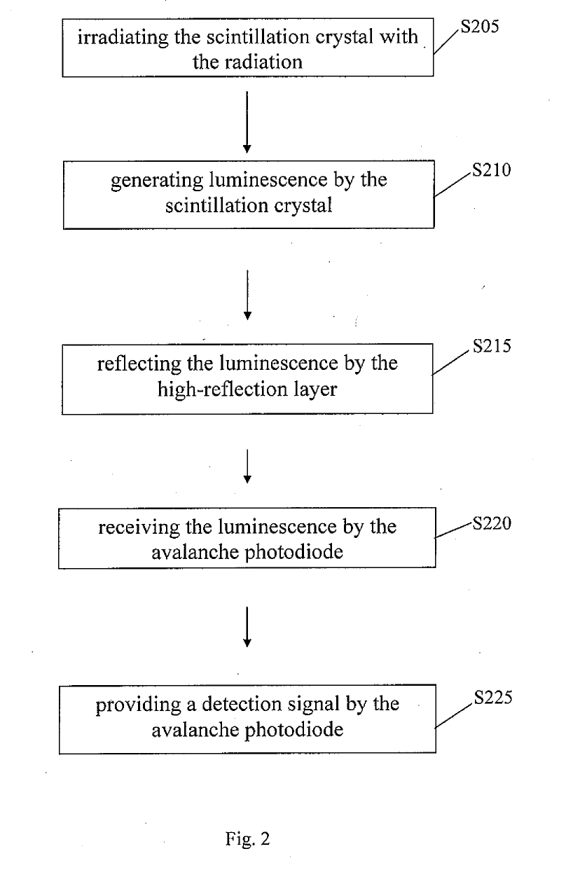

FIG. 2 presents the flow chart of the radiation-detecting method, according to the preferred embodiment of the present invention.

First, place the radiation-detecting device 1 in the preferred embodiment of the present invention in a testing environment, which includes radiation L₁. If the radiation L₁ does not exist in the testing environment, then scintillation crystal 11 in the present embodiment will not emit luminescence (F), and the avalanche photodiode 12 will not generate the detection signals. Therefore, the message displayed on display unit 15 is “no radiation”.

In step S205, when the scintillation crystal 11 is placed in the environment with radiation L₁ and the scintillation crystal 11 is illuminated by radiation L₁, the radiation passes through the high-reflection layer 13 into the scintillation crystal 11. Moreover, the high-reflection layer 13 in the present embodiment effectively blocks the spectrum of the visible light L₂, preventing interference from the visible light L₂ and substantially improving the accuracy of the radiation-detecting device 1.

In step S210, after the radiation L₁ enters the scintillation crystal 11, ionizing radiation excites the crystal 11 or the electrons in the molecules therein to the excited state. When the electrons return from the excited state to the ground state, luminescence (F) is generated. The strength of the luminescence increases with the intensity of radiation L₁. Therefore, the strength of the radiation can be determined from the strength of the luminescence.

In steps S215 and S220, most of the luminescence F undergoes at least one reflection via the high-reflection layer 13 to arrive at the avalanche photodiode 12, which receives both reflected and non-reflected luminescence F.

In step S225, the avalanche photodiode 12 generates a detection signal upon by receiving the luminescence F. Restated, the avalanche photodiode 12 can determine the strength of the radiation from the received photons of the luminescence F. Therefore, the strength of the detection signal is proportional to the luminescence F. The detection signal is delivered to the signal processing unit 14 for filtering, amplification, analog-to-digital conversion, and digital signal processing to yield a detection result. Thereafter, the display unit 15 displays the detection result, in the form of a value that represents the strength of the radiation.

In conclusion, the present radiation detecting device utilizes a scintillation crystal to generate luminescence under irradiation. The strength of the luminescence is determined by the strength of the radiation. The scintillation crystal initiates the generation of the optoelectrons by the interaction between the photon and the substance: when radiation is incident on the sodium iodide crystal, flashes of luminescence are generated and the production of optoelectrons initiated. After the optoelectrons have been counted by the avalanche photodiode, special electronic devices generate the detection signals, and the measured value will be adopted to determine the strength of the radiation. Since the rate of interaction of the avalanche photodiode is high, the required measuring time are mitigated. The size of the instrument is also greatly reduced to facilitate portability. Not only is the cost reduced, but also the disadvantages of complexity and required time delay are mitigated.

While the preferred embodiment of the invention has been described, various changes can be made without departing from the spirit and purpose of the invention.

What is claimed is:

1. A radiation detecting device, comprising:
a scintillation crystal, coated with a high-reflection layer; and
an avalanche photodiode, coupled to the scintillation crystal;
wherein when the radiation excites the scintillation crystal, the scintillation crystal emits luminescence, and the luminescence is reflected by the high-reflection layer for at least one time within the scintillation crystal before received by the avalanche photodiode, for the avalanche photodiode to generate a detecting signal.

2. The radiation detecting device as claimed in claim 1 further comprises a signal processing unit and a display unit, the signal processing unit couples to the avalanche photodiode, and the display unit couples to the signal processing unit.

3. The radiation detecting device as claimed in claim 1, wherein the high-reflection layer on the surface of the scintillation crystal blocks the visible light.

4. The radiation detecting device as claimed in claim 1, wherein the radiation transmits to the scintillation crystal through the high-reflection layer, and generates the luminescence.

5. The radiation detecting device as claimed in claim 1, wherein the scintillation crystal is funnel shaped, the avalanche photodiode is disposed at the opening of the funnel shaped scintillation crystal.

6. The radiation detecting device as claimed in claim 1, wherein the scintillation crystal is sodium iodide crystal.

7. A radiation detecting method, to coordinate with a scintillation crystal and an avalanche photodiode, wherein a high-reflection layer is coated on the surface of the scintillation crystal, and the avalanche photodiode couples to the scintillation crystal, the detecting method comprises:
irradiating the scintillation crystal with the radiation;
generating luminescence by the scintillation crystal;
reflecting the luminescence by the high-reflection layer;
receiving the luminescence by the avalanche photodiode; and
providing a detecting signal by the avalanche photodiode.

8. The detecting method as claimed in claim 7, wherein the scintillation crystal is sodium iodide crystal.

9. The detecting method as claimed in claim 7, further comprises: blocking the visible spectrum by the high-reflection layer.

10. The detecting method as claimed in claim 7, wherein the radiation transmits to the scintillation crystal through the high-reflection layer, and generates the luminescence.

11. The detecting method as claimed in claim 7, wherein the scintillation crystal is funnel shaped, the avalanche photodiode is disposed at the opening of the funnel shaped scintillation crystal.
